(19) United States
(12) Patent Application Publication
(10) Pub. No.: US 2024/0309252 A1
(43) Pub. Date: Sep. 19, 2024

(54) BINDING AGENT FOR CELLULOSE-CONTAINING MATERIALS AND A PRODUCT CONTAINING IT

(71) Applicant: Sestec Polska Sp. z o.o., Kraków (PL)

(72) Inventors: Anna SIERANC, Zaborze (PL); Paula BARYLAK, Gliwice (PL); Andrzej PYTLIK, Michalowice (PL); Hans Joachim EDELMANN, Bad Harzburg (DE)

(73) Assignee: Sestec Polska Sp. z o.o., Kraków (PL)

(21) Appl. No.: 18/017,423

(22) PCT Filed: Jul. 22, 2021
(86) PCT No.: PCT/PL2021/050056

§ 371 Date: Jan. 23, 2023

(30) Foreign Application Priority Data
Jul. 22, 2020 (PL) P.434762

(51) Int. Cl. C09J 189/00; B27N 3/00; B27N 3/02; B27N 3/04; C09J 11/04; C09J 11/06; C09J 105/00; C09J 197/00

(52) U.S. Cl. CPC C09J 189/005; B27N 3/002; B27N 3/02; B27N 3/04; C09J 11/04; C09J 11/06; C09J 105/00; C09J 197/005

(57) ABSTRACT

Easy to use and store. an environmentally friendly binding agent for cellulose-containing materials, without animal products, particularly suitable for use in the production of wood composites. and a composite material product obtained with the use of this binder is disclosed.

The invention relates to an ecological binding agent free of animal proteins in the form of an adhesive composition for cellulose-containing materials suitable for use in the production of wood composites.

Although adhesives based on animal proteins and starch are able to maintain bonding for long periods in dry conditions, the main problem of adhesives based on natural ingredients is their limited strength and water resistance. Casein, blood proteins, soybeans have been modified by chemical denaturation and heat treatment. At the beginning of the 20th century, this made it possible to achieve a significant improvement in the adhesive properties, thanks to which it was possible to apply the obtained adhesive modifications to the construction of aircraft propellers. [1], [2]

In the following years, the increased interest in synthetic polymers led to the development of the first synthetic resins: phenol-formaldehyde and urea-formaldehyde adhesives. They were stronger, waterproof and made it possible to glue materials for external applications, above all, they were efficient and repeatable, easy and relatively quick to obtain in large quantities. Natural adhesives have been pushed aside. Their use has been limited only to assembling musical instruments, creating some furniture or making decorative veneers. [2]-[6]

However, in recent years, formaldehyde-based adhesives have become very controversial. Formaldehyde is a toxic and carcinogenic substance with very high acute inhalation toxicity already observed at 3.1 mg/l [7]. Also other adhesives that eliminate formaldehyde from the production process, such as PMDI, are a threat to human health. The inhalation toxicity of PMDI is LD50>0.493 mg/l/4h (rat) [8]. In addition, the production of the vast majority of synthetic adhesives is based on the use of non-renewable resources-crude oil resources, and their production causes a significant increase in carbon dioxide emissions to the atmosphere through multiple, long-term polycondensation processes.

A formaldehyde-free binding agent for cellulose-containing materials, containing animal protein as the predominant binder component is known from patent WO 2017/157646 A1.

The object of the invention is to provide an alternative binding agent for cellulose-containing materials that would also be based on environmentally friendly, readily available and bio-renewable ingredients, but not particularly containing animal protein. At the same time, with a significant reduction in the protein content as such, it should make it possible to meet the requirements and standards applicable to products based on urea-formaldehyde resins.

Nowadays, it is important because the use of animal protein is a growing controversy, especially in some groups of consumers. More and more often we meet the expectations of vegetarians or vegans also posed to other products, not only food.

The main object of the invention is to prepare an industrial adhesive not only without the use of toxic and carcinogenic substances, but also without the use of animal protein. An additional object of the invention is to enable the gluing of crushed wood, which is a raw material for the production of wood-based panels that meet the existing standards for these products and to minimize the emission of formaldehyde from the finished product.

Unexpectedly, the objective thus defined has been achieved in the present invention.

The present invention relates to a formaldehyde-free binding agent for cellulose-containing materials, characterized in that it is a composition comprising:
a protein component of plant origin, preferably soy protein and/or rapeseed protein and/or gluten and/or pea protein and/or corn gluten in an amount of 1 to 25%,
a polyhydric alcohol containing from 2 to 10—OH groups, especially sorbitol, maltitol and glycerin, in an amount of 5% to 45%, preferably sorbitol in an amount of 10% to 30%,
protein modifiers—preferably salts or oxidants, especially sodium hydroxide or hydrogen peroxide, in an amount of 0.05-5%,
water in an amount up to 100%.

Preferably, the binding agent according to the invention is characterized by at least one of the following features:
it additionally contains urea in an amount of 3% to 20%, preferably in an amount of 7% to 15%;
it additionally contains hydrogen peroxide in an amount of 1% to 15%, preferably in an amount of 4% to 8%;
it additionally contains casein in an amount of 0.5% to 8%, preferably in an amount of 4% to 6%;
it additionally contains molasses in an amount of 2% to 20%, preferably in an amount of 5% to 10%;
it additionally contains water glass in an amount of 0.5% to 30%, preferably in an amount of 2% to 10%;
it additionally contains modified lignin derived from spruce wood in an amount of 1% to 15%, preferably in an amount of 5% to 10%,
it contains gluten in an amount of 1% to 10%, preferably in an amount of 2% to 5%;

### ADVANTAGES OF THE INVENTION

Developing a biodegradable, formaldehyde-free adhesive that uses natural by-products from industrial processes has enormous economic, social, environmental and health benefits. If agricultural, industrial and forestry waste is not used, for example, for animal feed, is incinerated in furnaces or stored-this is an additional factor in increasing climate warming by emission of greenhouse gases, and environmental pollution by contamination of soil, air and water. The use of food industry by-products to produce resins is an extremely interesting solution, not only because of the possibility of reducing waste generation. Thanks to the new application, it also has great potential to adapt to different production requirements, turning into a renewable resource, replacing the consumption of crude oil, the resource of which is declining every year.

The adhesion between an adhesive and its substrate depends on many factors, including how it occurs. In order to better understand the phenomenon of adhesion, explain the source and strength of adhesive bonds, many studies have been developed. They describe, inter alia, physico-chemical bonds between the adhesive and the substrate, consisting in the transfer or sharing of electrons between atoms and molecules of the adhesive and the substrate. Adhesion can also occur due to the help of physical-mechanical phenomena when the adhesive penetrates into the pores on the surface of the substrate. As a result, the bond strength is ensured by the penetration of the liquid or adhesive into the pores of the material where the adhesive hardens. Adhesion also occurs through adsorption when the formation of the bond between the adhesive and the substrate to be bonded is based on the presence of van der Waals forces. The bond strength is assumed to be determined by the direct reaction between the functional groups of the adhesive and the substrate.

Protein adhesives embodying the invention are classified as dispersion adhesives. They are characterized by the fact that they are fixed when the liquid phase is removed by evaporation into wood or the atmosphere. An important function, already at the stage of adhesive preparation, is played by intermolecular interactions, which in the gluing process affect the properties of the wood-based board. Due to the fact that the wood fiber is a porous material, after applying the adhesive to the fiber, penetration into voids occurs and then infiltration, which is even deeper penetration into the wall cell. Only low molecular weight components of the adhesive, capable of forming hydrogen bonds, are infiltrating. These phenomena are essential to achieve the desired mechanical properties of the bond.

Hydrogen bonds play an important role in bonding the adhesive. All the base components of the adhesives are capable of interacting on the principle of hydrogen bonding.

The key to the entire gluing process is the stage of board forming and pressing under the influence of high temperature and increased pressure. At this stage, the contact between the adhesive components and the wood is significantly increased, because the wood itself is a heterogeneous material and has a small contact area between its adjacent elements. The action of the steam generated under these conditions initiates the degradation of fiber components, i.e. hemicellulose, lignin and amorphous cellulose. As a consequence, products are formed that play a significant role in binding the fibers. In addition, at high temperatures, lignin becomes soft and reacts with the components of the adhesive due to condensation, which at the same time increases the bond strength.

The elevated temperature also causes irreversible denaturation of the protein, which should be taken into account when determining the composition of the adhesive composition, as it may also occur under the influence of the added ingredients. The glycerin present in the adhesives formulations according to the invention positively influences the hydration and thermodynamic stability of the protein. Due to its presence in adhesives, finished products made with its participation retain a greater amount of water compared to boards using formaldehyde glue.

Both chemical and mechanical/physical factors determine the quality of a wood adhesive. The ability of a protein to chemically interact with the wooden substrate depends on the number and type of “exposed” functional groups. An effective mechanical bond allows the adhesive to penetrate the surface of the substrate, which depends on how well the components are dispersed in its carrier, in the water.

In addition, the adhesion of protein adhesives is regulated by the viscosity. For obtaining the appropriate viscosity, fluidity and penetration of adhesive formulations, the aforementioned protein denaturation is important, which increases the adhesive properties. The processes of protein denaturation and decomposition, in the process of mixing and homogenization, result in the exposure of reactive functional groups, which allows easy access to interaction with the binding substrate. This can be achieved by mechanical and thermal treatment, hydrolysis at elevated temperatures and increasing the pH. The higher pH values of the formulas, obtained with metal hydroxides, not only help to denature the proteins, but also improve the adhesive properties of the glue and increase the rate of penetration into the pores of the wood.

A commonly used denaturing agent is also urea. Due to the active interaction with the hydroxyl groups of the protein, it breaks down hydrogen bonds, which opens and unfolds its compact structure. By exposing more hydrophobic functional groups, the water resistance of the adhesive should improve.

The binding agent according to the invention makes it possible to produce products from cellulose-containing raw materials, in particular for the production of fibreboards and particleboards. All products manufactured using the invention met the applicable standards.

The results of the tests carried out on selected products were compared with the PN-EN standards and with the internal standards of Sestec Polska Sp. z o. o. Standards for individual products are listed in Tables 1 and 2 below.

TABLE 1
PN-EN standards and Sestec standards for 3 mm fibreboards (MDF).

| | | Internal bond | | Absorption |
|---|---|---|---|---|
| MDF | Solids [%] | [MPa] | Swelling [%] | [%] |
| Sestec | 40 | 0.50 | 50 | 80 |
| standard | | | | |
| EN | — | 0.65 | 35 | — |
| standard | | | | |

TABLE 2
PN-EN 312 standards and Sestec standards for
individual classes of 16 mm particleboards

| | Product | | Internal bond | |
|---|---|---|---|---|
| Particleboards | class | Solid [%] | [MPa] | Swelling [%] |
| Sestec standard | P1 | 40 | 0.24 | 80 |
| EN standard | | — | 0.24 | — |
| Sestec standard | P2 | 40 | 0.35 | 50 |
| EN standard | | — | 0.35 | — |
| Sestec standard | P3 | 40 | 0.45 | 14 |
| EN standard | | — | 0.45 | — |

### DETAILED DESCRIPTION OF THE INVENTION

### Binder for Cellulose-Containing Materials Includes:

a) Polyols-polyhydric alcohols containing from 2 to 10—OH groups. Sorbitol, maltitol and glycerol are particularly preferred. It is preferable to use solutions with a content of 70-95%. It is particularly preferable to use sorbitol with a content of 70% by weight. The amount of polyol component in the binders according to the present invention ranges from 5 to 45% parts per hundred parts of the binding agent. More preferably, 10 to 20% is used. The final choice of polyol used depends on the specific application and final adhesive properties desired.
b) Plant proteins-a protein component of plant origin, soy protein and/or rapeseed protein and/or pea protein and/or gluten and/or corn gluten. Used in the form of a powder. Most preferably soy protein with a protein content of 70-95%, especially 85%. The amount of the protein component in the binder according to the present invention ranges from 3 to 25%. Generally, it should be stated that all the tested proteins met the standards expected for the finished product, but their preparation, quantity or method of incorporation into the mixture depends on the final application of the finished product.
c) protein modifiers-preferably metal hydroxides or oxidizing agents, preferably metal hydroxides of groups I and II, particularly preferably sodium or calcium hydroxide, in powder or flake form. Most preferably NaOH, while the oxidizing agents are preferably hydrogen peroxide and/or potassium permanganate, more preferably perhydrol.
   The amount of protein modifier is 0.05-5%, preferably 0.1-1%, most preferably 0.5%.

In addition, taking into account the appropriately selected application, primarily the type of material desired to obtain the finished product, the type of glued material or the production process itself, it may be beneficial to use additional ingredients such as: amide compound, especially urea, casein, molasses, water glass, modified lignins, melamine derivatives, corn broth. The role of these ingredients and their influence on binder properties are discussed in more detail in the examples below.

### I. Protein Optimization

In order to select the appropriate protein of plant origin, the following were used:
wheat gluten
corn gluten
rapeseed protein
brown rice protein
pea protein
corn protein
soy protein

Most of them formed a slurry upon contact of the water-glycerin mixture, then sedimented over time. A number of protein modifying agents have been used to eliminate this phenomenon, including sodium, calcium, magnesium hydroxide, maleic anhydride, urea. It turned out to be most favorable to use sodium hydroxide and urea separately as well as to use both components simultaneously.

Mixtures were prepared, thanks to which not only the process of selecting proteins was carried out, but also the selection of appropriate liquid components, such as molasses, glycerin, sorbitol and vegetable oil, positively influencing the properties of adhesives. The formula contains 49.5% of water, 0.5% of sodium hydroxide, 12.5% of protein, 12.5% of urea and 25% of liquid additive.

For the development of the present invention, 3 mm medium density fiberboards were selected for testing. Pine fiber mixed with a binder was used by spraying under appropriate conditions and forming a mat. The amount of binder was from 8 to 13% solid adhesive based on dry wood. Preferably 10-12%. Most preferably 11%. The mat was pressed at a temperature of 170-230° C., preferably 180-220° C., most preferably 190-210° C. under pressure with a pressing time of 7-13 s/mm of the board thickness, preferably 8-11 s/mm, most preferably 10 s/mm. The optimal time also depends on the humidity of the mat and the air humidity in the production room.

TABLE 3
Results for 3 mm MDF boards with the use of a variety of proteins and liquid ingredients.

| | | | | | Product thickness [mm] | | | |
|---|---|---|---|---|---|---|---|---|
| | | | | | 3 mm | | | |
| | | | | | | Internal | | |
| | | Protein | | Solids | Density | bond | Swelling | Absorption |
| No. | Adhesive | source | Additive | [%] | [kg/m3] | [MPa] | [%] | [%] |
| Sestec | | | | 40 | — | 0.50 | 50 | 80.0 |
| standard | | | | | | | | |
| EN | | | | — | — | 0.65 | 35.0 | — |
| standard | | | | | | | | |
| 1. | W0041A | Corn | Glycerine | 45 | 755.0 | 0.55 | 40.4 | 77.5 |
| | | | Sorbitol | 43 | 775.0 | 0.62 | 39.8 | 82.2 |
| | | | Molasses | 45 | 802.0 | 0.82 | 55.5 | 82.3 |
| | | | Vegetable oil | 45 | 860.0 | 0.72 | 56.2 | 84.5 |
| 2. | W0041B | Corn | Glycerine | 45 | 750.0 | 0.55 | 38.3 | 66.9 |
| | | gluten | Sorbitol | 43 | 781.0 | 0.92 | 40.5 | 70.9 |
| | | | Molasses | 45 | 761.0 | 0.81 | 47.6 | 78.7 |
| | | | Vegetable oil | 45 | 796.0 | 1.26 | 38.5 | 63.3 |
| 3. | W0041C | Gluten | Glycerine | 45 | 781.0 | 1.02 | 23.2 | 70.8 |
| | | | Sorbitol | 43 | 780.0 | 1.03 | 31.9 | 79.7 |
| | | | Molasses | 45 | 761.0 | 0.71 | 34.9 | 89.0 |
| | | | Vegetable oil | 45 | 775.0 | 0.82 | 34.7 | 88.3 |
| 4. | W0041D | Pea | Glycerine | 45 | 844.0 | 1.37 | 29.0 | 69.6 |
| | | | Sorbitol | 43 | 841.0 | 1.23 | 32.9 | 74.1 |
| | | | Molasses | 45 | 823.0 | 1.43 | 34.7 | 80.5 |
| | | | Vegetable oil | 45 | 838.0 | 1.07 | 33.8 | 78.4 |
| 5. | W0041 E | Soy | Glycerine | 45 | 841.0 | 1.33 | 33.5 | 72.3 |
| | | | Sorbitol | 43 | 817.0 | 1.21 | 30.4 | 77.4 |
| | | | Molasses | 45 | 832.0 | 1.42 | 35.0 | 78.5 |
| | | | Vegetable oil | 45 | 845.0 | 1.19 | 34.8 | 75.6 |
| 7. | W0041G | Brown | Glycerine | 45 | 853.0 | 0.83 | 43.2 | 86.1 |
| | | rice | Sorbitol | 43 | 842.0 | 0.71 | 49.0 | 94.5 |
| | | | Molasses | 45 | 811.0 | 0.66 | 51.2 | 90.1 |
| | | | Vegetable oil | 45 | 824.0 | 0.59 | 43.6 | 83.4 |
| 8. | W0041H | Bio rice | Glycerine | 45 | 826.0 | 0.76 | 60.0 | 111.4 |
| | | | Sorbitol | 43 | 831.0 | 0.78 | 84.2 | 134.6 |
| | | | Molasses | 45 | 844.0 | 0.72 | 76.9 | 119.5 |
| | | | Vegetable oil | 45 | 849.0 | 0.69 | 71.4 | 115.7 |

The results were compared with an internal standard established by Sestec (Table 3). All proteins met the minimum internal standard of Sestec in terms of strength parameters. Some, however, did not fall within the specified range of allowable swelling and, at the same time, water absorption. Soybeans, peas and gluten showed the most favorable properties, thanks to which they were able to meet the standard European standards. These proteins were used for further modifications and the creation of potential ready-made formulas.

### II. MDF Boards

For the development of the present invention, fiberboards of medium density and a thickness of 3 mm were selected for testing, pine fiber mixed with a binder was used by spraying under appropriate conditions and forming a mat. The amount of binder was from 8 to 13% solid adhesive based on dry wood. Preferably 10-12%. Most preferably 11%. The mat was pressed at a temperature of 170-230° C., preferably 180-220° C., most preferably 190-210° C. under pressure with a pressing time of 7-13 s/mm of the board thickness, preferably 8-11 s/mm, most preferably 10 s/mm. The optimal time also depends on the humidity of the mat and the air humidity in the production room. At the same time, rapeseed proteins, modified starches and soy protein were selected for the MDF boards as representative of the above-mentioned tested proteins. The results obtained in the whole group of proteins are comparable, however, selected are commercially available in amounts enabling their industrial use.

### 1. Rapeseed Protein

TABLE 4
Exemplary compositions of the binding agent according to the invention
for 3 mm thick MDF boards with the use of rapeseed protein (wt %).

| | | | | | | | |
|---|---|---|---|---|---|---|---|
| Product | W0090 | A | B | C | D | E | F |

Components

| | | | | | | | |
|---|---|---|---|---|---|---|---|
| Water | 74 | 73.5 | 24 | 24 | 42.8 | 30.5 | 30.5 |
| Rapeseed protein | 5 | 5.4 | 4.75 | 4.75 | 7 | 3 | 3 |
| Glycerin | 21 | 21 | 47.25 | 47.25 | 50 | 60.5 | 60.5 |
| NaOH | — | 0.1 | — | — | 0.2 | — | — |
| Water glass | — | — | 24 | — | — | — | — |
| Corn broth | — | — | — | 24 | — | — | — |
| Gluten | — | — | — | — | — | 6 | — |
| Urea | — | — | — | — | — | — | 6 |

Properties

| | | | | | | | |
|---|---|---|---|---|---|---|---|
| pH | 6.4 | 9.8 | 11.3 | 4.2 | 9.0 | 6.15 | 6.4 |
| Solids % | 23 | 23 | 54 | 54 | 50 | 60 | 60 |

| | | | | | | | | Sestec | PN-EN |
|---|---|---|---|---|---|---|---|---|---|
| Results | | | | | | | | standard | standard |
| Internal bond [MPa] | 0.66 | 2.05 | 1.50 | 1.05 | 2.20 | 1.70 | 1.67 | 0.55 | 0.65 |
| Swelling [%] | 17.75 | 18.33 | 38.00 | 38.00 | 24.85 | 36.20 | 33.12 | 50 | 35.00 |
| Absorption [%] | 53.75 | 44.42 | 91.70 | 80.00 | 57.68 | 77.40 | 73.66 | 80 | — |

Rapeseed protein and roughage concentrate

TABLE 5
Exemplary compositions of the binding agent according to the invention for 3 mm thick
MDF boards with the use of rapeseed protein and roughage concentrate (wt %).

| | | | | | | | |
|---|---|---|---|---|---|---|---|
| Product | W0030 | A | B | C | D | E | F |

Components

| | | | | | | | |
|---|---|---|---|---|---|---|---|
| Water | 74 | 73 | 38.5 | 38.5 | 47 | 30 | 28.55 |
| Rapeseed protein | 5 | 5 | 4 | 4 | 4.8 | 3 | 3 |
| and roughage | | | | | | | |
| concentrate | | | | | | | |
| Glycerin | 21 | 21 | 38.5 | 38.5 | 47 | 60 | 57 |
| NaOH | — | 1 | — | — | 0.2 | — | 0.05 |
| Water glass | — | — | — | 19 | — | — | — |
| Corn broth | — | — | 19 | — | — | — | — |
| Gluten | — | — | — | — | — | 6 | — |
| Molasses | — | — | — | — | — | — | 11.4 |
| Emulsion | — | — | — | — | 1 | 1 | — |

Properties

| | | | | | | | |
|---|---|---|---|---|---|---|---|
| pH | 5.3 | 12.7 | 4.0 | 11.0 | 7.0 | 5.7 | 6.4 |
| Solids % | 23 | 23 | 44 | 44 | 45 | 60 | 60 |

| | | | | | | | | Sestec | PN-EN |
|---|---|---|---|---|---|---|---|---|---|
| Results | | | | | | | | standard | standard |
| Internal bond [MPa] | 0.66 | 0.69 | 0.86 | 0.33 | 0.63 | 1.12 | 1.10 | 0.5 | 0.65 |
| Swelling [%] | 36.2 | 26.7 | 50.1 | 111.0 | 72.1 | 53.3 | 61.1 | 50 | 35.00 |
| Absorption [%] | 75.3 | 61.9 | 92.0 | 188.0 | 113.7 | 93.8 | 110.4 | 80 | — |

The mixing of the solutions described above is preferably carried out in an alkaline environment and at a temperature of 15-35° C., especially 20-25° C.

The roughage contained in the rapeseed protein concentrate is an ingredient with hydrophilic properties. The acceptable amount of this substance used in the adhesive composition is limited by the amount of water absorbed by it. The use of roughage in production results in a strong swelling of the finished products, which may result in non-compliance with the water resistance standards in accordance with the PN-EN 622-5 standard for dry-formed MDF boards.

The most favorable results were obtained for the “D” formula presented in Table 4. It was then used to test the properties of an 8 mm thick MDF board made with the same parameters, for which the obtained intenral bond was also above the standard—0.8 MPa.

### 2. Soy Protein

TABLE 6
Exemplary compositions of the binding agent according to the invention
for 3 mm thick MDF boards with the use of soy protein (wt %).

| | | | | | | | | | | |
|---|---|---|---|---|---|---|---|---|---|---|
| Adhesive | W33A | W33B | W27A | W27B | W14A | W14B | W35A | W35B | W36A | W36B |

Components

| | | | | | | | | | | |
|---|---|---|---|---|---|---|---|---|---|---|
| Water | 41.9 | 44.0 | 14.3 | 15.4 | 65.9 | 39.4 | 49.3 | 15.9 | 41.0 | 36.4 |
| Defoaming agent | 0.1 | 0.1 | 0.1 | 0.1 | 0.1 | 0.1 | 0.1 | 0.1 | 0.1 | 0.1 |
| Glycerin | 18.0 | 19.0 | 57.0 | 29.5 | 17.0 | 39.5 | 18.5 | 16.0 | 21.0 | 36.5 |
| Perhydrol | 5.0 | — | 14.3 | 4.0 | — | — | — | — | — | — |
| NaOH | — | 0.5 | — | — | — | — | 0.6 | — | 0.4 | 0.5 |
| Molasses | 18.0 | 19.0 | — | — | — | — | — | — | 10.5 | 9.0 |
| Soy protein | 17.0 | 17.5 | 14.3 | 12.0 | 17.0 | 10.5 | 8.5 | 7.0 | 21.0 | 14.5 |
| Corn broth | — | — | — | 39.0 | — | — | — | 42.5 | — | — |
| Urea | — | — | — | — | — | 10.5 | — | — | — | — |
| Caprolactam | — | — | — | — | — | — | 6.0 | 5.5 | 4.0 | 3.5 |
| Gluten | — | — | — | — | — | — | 8.5 | 7.5 | — | — |
| Oil | — | — | — | — | — | — | 6.0 | 5.5 | — | — |
| Water glass | — | — | — | — | — | — | 2.5 | — | 2.0 | — |

To produce a medium density fiberboard, 3 mm thick, pine fiber mixed with a binding agent was used by spraying under suitable conditions and forming a mat. The amount of binder was from 8 to 13% solid adhesive based on dry wood. Preferably 10-12%. Most preferably 11%. The mat was pressed at a temperature of 170-230° C., preferably 180-220° C., most preferably 190-210° C. under pressure with a pressing time of 7-13 s/mm of the board thickness, preferably 8-11 s/mm, most preferably 10 s/mm. The optimal time also depends on the humidity of the mat and the air humidity in the production room.

All parameters of boards created with the formulas listed in Table 6 meet the requirements of both the standard established by Sestec and PN-EN 622-5 for dry-formed MDF boards. The results are presented in Table 7.

TABLE 7
Results for 3 mm thick MDF boards with the use of
soy protein according to the formulas in Table 6

| | | | | Internal | Swell- | |
|---|---|---|---|---|---|---|
| | | Solids | Density | bond | ing | Absorption |
| No. | Adhesive | [%] | [kg/m³] | [MPa] | [%] | [%] |
| PN-EN | | — | — | 0.65 | 35.0 | — |
| standard | | | | | | |
| Sestec | | 40 | — | 0.50 | 50.0 | 80.0 |
| standard | | | | | | |
| 1. | W0033A | 47 | 750.0 | 1.62 | 35.0 | 65.3 |
| | | | 800.0 | 1.81 | 26.0 | 56.3 |
| 2. | W0033B | 48 | 750.0 | 1.63 | 33.1 | 65.2 |
| | | | 800.0 | 1.97 | 26.2 | 57.0 |
| 3. | W0027A | 60 | 750.0 | 1.43 | 25.5 | 47.2 |
| | | | 800.0 | 1.76 | 25.3 | 54.0 |
| 4. | W0027B | 57 | 750.0 | 1.31 | 32.1 | 55.6 |
| | | | 800.0 | 2.15 | 30.9 | 53.0 |
| 5. | W0014A | 30 | 750.0 | 1.40 | 23.2 | 59.3 |
| | | | 800.0 | 1.53 | 22.8 | 58.0 |
| 6. | W0014B | 54 | 750.0 | 1.67 | 29.7 | 57.2 |
| | | | 800.0 | 1.75 | 28.0 | 59.5 |
| 7. | W0035A | 46 | 750.0 | 1.24 | 34.5 | 61.6 |
| | | | 800.0 | 1.49 | 31.8 | 57.9 |
| 8. | W0035B | 60 | 750.0 | 1.50 | 34.3 | 70.7 |
| | | | 800.0 | 1.74 | 32.5 | 55.7 |
| 9. | W0036A | 56 | 750.0 | 1.50 | 32.1 | 57.3 |
| | | | 800.0 | 1.60 | 29.6 | 52.1 |
| 10. | W0036B | 51 | 750.0 | 1.57 | 27.4 | 55.8 |
| | | | 800.0 | 1.72 | 29.7 | 52.5 |

Formulas 1, 2, 3 and 4 according to Table 7 were used to create boards with a thickness of 6 mm according to the same parameters. The results are summarized in Table 8. All values are consistent with both the standard established by Sestec and the PN-EN 622-5 standard for dry-formed MDF boards.

TABLE 8
Results for 6 mm thick MDF boards with the use of soy
protein according to the formulas in Table 6

| | | Density | Internal bond | Swelling | Absorption |
|---|---|---|---|---|---|
| No. | Adhesive | [kg/m³] | [MPa] | [%] | [%] |
| Standard | | — | 0.65 | 30.0 | — |
| 1. | W0033A | 850.0 | 0.83 | 29.6 | 51.7 |
| 2. | W0033B | 850.0 | 0.75 | 24.9 | 50.2 |
| 3. | W0027A | 850.0 | 0.80 | 24.3 | 53.5 |
| 4. | W0027B | 850.0 | 0.74 | 25.1 | 42.3 |

### III. Particleboards

For the development of the present invention, single-layer particleboards with a density of 660±30 kg/m³ and a thickness of 16 mm were selected for subsequent tests. Pine chips mixed with a binding agent were used by spraying under appropriate conditions and forming a mat. The amount of binder was from 7 to 13% solid adhesive based on dry wood. Preferably 9-12%. Most preferably 11%. The mat was pressed at a temperature of 170-230° C., preferably 180-220° C., most preferably 190-210° C. under pressure with a pressing time of 7-15 s/mm of board thickness, preferably 8-13 s/mm, most preferably 10 s/mm of board thickness. The optimal time also depends on the humidity of the mat and the air humidity in the production room.

### 1. Soy Protein, Pea Protein and Casein

TABLE 9
Exemplary compositions of the binding agent according
to the invention for particleboards with the use of
pea protein, casein and/or soy protein (wt %).

| | | | | | | |
|---|---|---|---|---|---|---|
| Adhesive | W19R | W19S | W19SW | W19US | W19UG | W19WG |

Components

| | | | | | | |
|---|---|---|---|---|---|---|
| Water | 46.4 | 48 | 47 | 39.9 | 39.9 | 42.5 |
| De- | 0.1 | 0.1 | — | 0.1 | 0.1 | 0.1 |
| foaming | | | | | | |
| agent | | | | | | |
| Glycerin | 23.0 | 36 | 35 | — | 30 | 28.4 |
| NaOH | 0.5 | 0.5 | 0.5 | 0.5 | 0.5 | 0.5 |
| Molasses | 16.0 | — | — | — | — | — |
| Sorbitol | — | — | — | 30 | — | — |
| Soy | — | 3.6 | 3.5 | 4.5 | 4.5 | 4.3 |
| protein | | | | | | |
| Pea | 7 | 4.8 | 4.8 | 4 | 6 | 5.7 |
| protein | | | | | | |
| Casein | 7 | 7 | 7 | 6 | 4 | 3.8 |
| Urea | — | — | — | 15 | 15 | 14.2 |
| Water | — | — | 2 | — | — | 0.5 |
| glass | | | | | | |

TABLE 10
Results for particleboards with the use of pea protein,
casein and/or soy protein according to the formulas in Table 9.

| | | | Internal bond | Swelling |
|---|---|---|---|---|
| No. | Adhesive | Solids [%] | [MPa] | [%] |
| P1 class | Sestec standard | 40 | 0.24 | — |
| | PN-EN standard | — | 0.24 | 80 |
| P2 class | Sestec standard | 40 | 0.35 | — |
| | PN-EN standard | — | 0.35 | 50 |
| P3 class | Sestec standard | 40 | 0.45 | 14 |
| | PN-EN standard | — | 0.45 | 14 |
| 1. | W0019R | 47 | 0.28 | 35.70 |
| 2. | W0019S | 46 | 0.30 | 39.93 |
| 3. | W0019US | 50 | 0.27 | 68.30 |
| 4. | W0019SW | 46 | 0.50 | 13.9 |
| 5. | W0019UG | 55 | 0.37 | 46.2 |
| 6. | W0019WG | 54 | 0.45 | 13.8 |

The mixing of the solutions described above is preferably carried out in an alkaline environment and at a temperature of 15-35° C., especially 20-25° C.

The results were compared with the internal Sestec standard and PN-EN 312 standard. The adhesive joints described in Table 9 according to the formulas W0019R, W0019S and W0019US meet the strength standards for P1 class adhesives, while the adhesive compositions W0019SW, W0019UG and W0019WG meet the strength standards for the P2 class of particleboards. P1 and P2 classes do not require water resistance. For a better analysis, the results of the swelling after soaking in water were additionally compared with the internal Sestec standard. (Table 10).

Significant improvement in the strength parameters of the boards was observed after adding soy protein and water glass to the adhesive composition. The addition of water glass improved the internal bond by 0.08-0.2 MPa and the swelling results after soaking in water by 5-7%. There was no positive effect of casein and the amount of its use on the water resistance of the board.

The most favorable results were obtained for the W0019SW and W0019WG formulas. Strength results were met even for more demanding classes. The very good swelling in thickness after soaking in water also met the requirements of the standard for P3 class. All the adhesive formulations met the Sestec standard for a minimum solids content of >40%.

### 2. Soy Protein, Gluten or Pea Protein

TABLE 11
Exemplary compositions of the binding agent according
to the invention for particleboard using soy protein
and gluten or pea protein (wt %).

| | | | | | | |
|---|---|---|---|---|---|---|
| Adhesive | W25 | W25WG | W35A | W35B | W35D | W35Z |

Components

| | | | | | | |
|---|---|---|---|---|---|---|
| Water | 44.5 | 42.2 | 49.0 | 15.7 | 43.2 | 49.0 |
| Defoaming | 0.1 | 0.1 | 0.1 | 0.1 | 0.1 | 0.1 |
| agent | | | | | | |
| Glycerin | 35.5 | 31 | 18.4 | 15.9 | 18.5 | 18.4 |
| NaOH | 0.1 | 0.1 | 0.6 | — | — | 0.6 |
| Perhydrol | — | — | — | — | 6.2 | — |
| Oil | — | — | 6.1 | 5.4 | 6.2 | 6.1 |
| Caprolactam | 5.4 | 3.1 | 6.1 | 5.4 | 6.2 | 6.1 |
| Soy protein | 5.4 | 6.2 | 8.6 | 7.5 | 8.6 | 8.6 |
| Pea protein | 9 | 6.3 | — | — | — | — |
| Casein | — | — | 6.1 | — | — | — |
| Gluten | — | — | 8.6 | 7.5 | 8.6 | 8.6 |
| Water glass | — | 11 | 2.5 | — | — | 2.5 |
| Corn broth | — | — | — | 42.5 | — | — |

TABLE 12
Results for particleboards with the use of soy protein and gluten or
or pea protein according to the formulas in Table 11.

| | | | Internal bond | Swelling |
|---|---|---|---|---|
| No. | Adhesive | Solids [%] | [MPa] | [%] |
| P1 class | Sestec standard | 40 | 0.24 | 80 |
| | PN-EN standard | — | 0.24 | — |
| P2 class | Sestec standard | 40 | 0.35 | 50 |
| | PN-EN standard | — | 0.35 | — |
| 1. | W0025 | 50 | 0.30 | 65.15 |
| 2. | W0025 WG | 47 | 0.34 | 61.18 |
| 3. | W0035 A | 46.5 | 0.35 | 52.64 |
| 4. | W0035 B | 48.5 | 0.13 | 59.18 |
| 5. | W0035 D | 47 | 0.22 | 60.02 |
| 6. | W0035 Z | 47 | 0.14 | 58.02 |

The results were compared with the internal Sestec standard and PN-EN 312 standard. The adhesive joints described in Table 11 according to the formulas W0025 and W0025WG meet the internal bond norms for P1 class adhesives. The adhesive composition W0035A meets the strength standards for the P2 class of particleboards according to PN-EN 312, however, it does not meet the Sestec standard for the swelling test after soaking in water. P1 and P2 classes do not require water resistance. Therefore, for a deeper analysis, an internal standard (Sestec standard) was introduced and the results for the swelling in thickness after soaking in water are also included in the summary of the results (Table 12).

Taking into account all the glue joints described in the patent, a positive correlation between casein and gluten has been shown, thanks to which the strength parameters and water resistance of the boards are improved. The removal of casein in the W0035Z recipe did not cause any changes in the strength parameters of the finished products. Replacing some of the water with corn broth resulted in a minimal increase in strength. However, it did not improve the water resistance of particleboards.

A significant effect of the addition of pea protein on the parameters of the finished product was demonstrated. Compared to the formulas with the addition of gluten, even 2.5 times better results were achieved with pea protein.

### 3. Soy Protein

TABLE 13
Exemplary compositions of the binding agent according to the invention
for particleboard with the use of soy protein (wt %).

| | | | | | | | | | | |
|---|---|---|---|---|---|---|---|---|---|---|
| Adhesive | W33A | W33B | W33D | W33H | W33I | W33J | W33K | W33L | W33M | W33W |

Components

| | | | | | | | | | | |
|---|---|---|---|---|---|---|---|---|---|---|
| Water | 42.1 | 44 | 44 | 41.4 | 44 | 41.3 | 39.1 | 48.3 | 45 | 41.3 |
| Defoaming agent | 0.1 | 0.1 | 0.1 | 0.1 | 0.1 | 0.1 | 0.1 | 0.1 | 0.1 | 0.1 |
| Glycerin | 18.1 | 18.9 | — | 17.8 | 18.9 | 17.8 | 16.8 | 31.7 | 19.4 | 17.8 |
| Perhydrol | 4.8 | — | — | — | — | — | — | — | — | — |
| Sorbitol | — | — | 18 | — | 18.9 | — | — | — | — | — |
| NaOH | — | 0.5 | 0.5 | 0.5 | 0.5 | 0.5 | 0.4 | 0.6 | 0.5 | 0.5 |
| Water glass | — | — | — | 5.9 | — | — | 5.6 | — | 3.9 | — |
| Molasses | 18.1 | 18.9 | 18 | 17.8 | — | 17.8 | 16.8 | — | — | 17.8 |
| Soy protein | 16.8 | 17.6 | 16.7 | 16.6 | 17.6 | 16.6 | 15.6 | 19.3 | 18.1 | 16.6 |
| Oil | — | — | — | — | — | — | 5.6 | — | 6.5 | — |
| Caprolactam | — | — | — | — | — | — | — | — | 6.5 | — |
| Casein | — | — | 2.7 | — | — | — | — | — | — | — |
| Dextrin | — | — | — | — | — | 5.9 | — | — | — | — |
| Emulsion | — | — | — | — | — | — | — | — | — | 5.9 |

TABLE 14
Results for particleboards with the use of soy protein according to the formulas in Table 13.

| P1 class | | | | | P2 class | | | | |
|---|---|---|---|---|---|---|---|---|---|
| | | | Internal | | | | | Internal | |
| | | Solids | bond | Swelling | | | Solids | bond | Swelling |
| No. | Adhesive | [%] | [MPa] | [%] | No. | Adhesive | [%] | [MPa] | [%] |
| Sestec standard | | 40 | 0.24 | 80 | Sestec standard | | 40 | 0.35 | 50 |
| PN-EN standard | | — | 0.24 | — | PN-EN standard | | — | 0.35 | — |
| 1. | W0033 A | 47 | 0.30 | 50.24 | 1. | W0033 H | 48 | 0.46 | 13.6 |
| 2. | W0033 B | 49 | 0.27 | 65.12 | 2. | W0033 I | 47 | 0.44 | 13.7 |
| 3. | W0033 D | 46 | 0.34 | 68.72 | 3. | W0033 J | 53 | 0.35 | 67.4 |
| 4. | W0033 K | 51 | 0.32 | 51.63 | 4. | W0033 L | 51 | 0.37 | 20.3 |
| 5. | W0033 M | 49 | 0.34 | 53.73 | 5. | W0033 W | 49 | 0.39 | 41.8 |

The results were compared with the PN-EN 312 standard and the internal Sestec standard. The adhesive joints described in Table 13 according to the formulas W0033A, W0033B, W0033D, W0033K and W0033M meet the strength standards for P1 class, while the adhesive compositions W0033J, W0033L and W0033W meet the strength standards for the P2 class of particleboards. P1 and P2 classes do not require water resistance. For deeper analysis, the results for the swelling in thickness are also included in the summary of the results (Table 14). Taking this parameter into account, the parameters for the P3 class were also met in the case of the compositions W0033H and W00331.

A positive effect on the strength parameters of the boards was demonstrated by the use of, inter alia, such additives as: water glass, sorbitol, dextrin and emulsion. All these formula additives resulted in an increase in internal bond, which allowed them to be classified as P2 class.

Depending on the formula, the removal of molasses from the adhesive composition also contributed to the increase in strength and a significant improvement in the water resistance of the boards by 50-100%. No positive effect of casein on product parameters has been demonstrated.

Removal of the molasses does not necessarily have a positive effect on the strength parameters of the board. The best strength results were obtained for the W0033H adhesive composition in which the above-mentioned additive is present.

### IV. Formaldehyde Emission Test

At the Wood Technology Institute in Poznań, formaldehyde emission tests were carried out using the chamber method in accordance with the PN-EN 717-1:2006 standard. The results are shown in Table 15.

The aim was to demonstrate the reduction of formaldehyde emission from natural wood by gluing pine fibers with adhesive joints developed according to the invention.

As a reference sample (No. 1), a board was made using only pine fiber for the production of MDF boards, from which the mat was made, and then pressed under the same conditions as in the production of other boards. For the production of samples 2 and 3, pine fiber mixed with a binder was used by spraying under appropriate conditions and forming a mat. The amount of binder was 11% solid adhesive based on dry wood. The mat was pressed at 210° C. under pressure with a pressing time of 10 s/mm of board thickness.

TABLE 15
The results of formaldehyde emission testing
using the chamber method on MDF boards.

| | | | | Formaldehyde | |
|---|---|---|---|---|---|
| Sample | | Chamber conditions | | emission | |
| No. | Name | Temperature | Humidity | [mg/m³] | [ppm] |
| 1 | Fiber | 23 ± 0.5° C. | 45 ± 3% | 0.139 | 0.113 |
| 2 | W0027D | | | 0.033 | 0.026 |
| 3 | W0033B | | | 0.050 | 0.041 |

The obtained results confirm the absence of formaldehyde in the developed formulas. Additionally, they confirm the binding of proteins with aldehydes, in this case with formaldehyde contained in the wood itself. This allows to reduce the emission of toxic aldehyde by up to 64-77%.

Additionally, received results confirm the fulfillment of the assumptions of the invention in the scope of limiting the emission of formaldehyde from the finished glued product against a pure wooden mat without any glue.

### BIBLIOGRAPHY

[1] Cheng H. N., He Z., Wood Adhesives Containing Proteins and Carbohydrates. W: Bio-based Wood Adhesives. Preparation, characterization, and testing, Z. He (red.), CRC Press Taylor & Francis Group, 2017, 141-142.
[2] Vnuc̆ec D., S̆ernek M., Kutnar A., Gors̆ek A., Proteinska lepila na osnovi soje, krvi in kazeina nekooc̆ in danes. Past and present protein adhesives based on soy, blood and casein. Acta silvae ligni, 2017, R. 112, 35-47.
[3] Vnuc̆ec D., Kutnar A., Gors̆ek A., Soy-based adhesives for wood-bonding—a review. Journal of Adhesion Science and Technology, 2017, R. 31, nr 8, 910-931.
[4] Pizzi A., Mittal K., Keimel F. A. Historical Development of Adhesives and Adhesive Bonding. W: Handbook of Adhesive Technology 2^{nd}, A. Pizzi, K. L. Mittal, Marcel Dekker, New York 2003, 1-12.
[5] Lukas A., Problems in Connection with Ancient Egyptian Materials. W: Analyst, 1926, R. LI, nr 606, 435-450.

[6] Brockmann W., GeiβP. L., Klingen J., Schröder B., The Historical Development of Adhesive Bonding. W: Adhesive Bonding. Materials, Applications and Technology. Weinheim: WILEY-VCH Verlag Gmbh & Co. KGaA, Weinheim 2009, 5-10.

[7] Merck, Safety Data Sheet. Formaldehyde, 4% solution, buffered, pH 6.9 (approx. 10% formalin solution), for histology. Darmstadt 2018, 1-9.

[8] BASF, Safety Data Sheet. ELASTOFLEX* TE 3450 C-B P-MDI. Lemfoerde 2019, 1-16.

In the claims:

1. A binding agent for cellulose-containing materials, characterized in that it contains following ingredients:
a protein component of a plant origin, preferably selected from the group comprising: soy protein, rapeseed protein, gluten, pea protein and corn gluten, in an amount of 3 to 25%,
a polyhydric alcohol containing from 2 to 10—OH groups, preferably selected from the group comprising: sorbitol, maltitol and glycerin, in an amount of 5% to 45%, especially sorbitol in an amount of 10% to 30%,
a protein modifier selected from the group comprising metal hydroxides or oxidizing agents, especially sodium hydroxide or hydrogen peroxide, in an amount of 0.05 -5%,
water up to 100%.

2. The binding agent according to claim 1, characterized in that it further contains urea in an amount of 3% to 20%, preferably in an amount of 7% to 15%.

3. The binding agent according to claim 1, characterized in that it further contains hydrogen peroxide in an amount of 1% to 15%, preferably in an amount of 4% to 8%.

4. The binding agent according to claim 1, characterized in that it further contains casein in an amount of 0.5% to 8%, preferably in an amount of 4% to 6%.

5. The binding agent according to claim 1, characterized in that it further contains molasses in an amount of 2% to 20%, preferably in an amount of 5% to 10%.

6. The binding agent according to claim 1, characterized in that it further contains water glass in an amount of 0.5% to 30%, preferably in an amount of 2% to 10%.

7. The binding agent according to claim 1, characterized in that it further contains gluten in an amount of 1% to 10%, preferably in an amount of 2% to 5%.

8. The binding agent according to claim 1, characterized in that it further contains a modified lignin, especially derived from spruce wood, in an amount of 1% to 15%, preferably in an amount of 5% to 10%.

9. A composite material product obtained by binding a cellulose-containing starting material to a binding agent according to claim 1 and forming it into a product.

10. The composite material product according to claim 9, characterized in that the starting material is wood, in particular wood fiber or wood shavings, straw from cereals, rice, rapeseed, poppy, corn, flax, sunflower and/or paper.

11. A composite material product according to claim 9, characterized in that it is a board, preferably a pressed board or a laminate.

12. A composite material product obtained by binding a cellulose-containing starting material to a binding agent according to claim 2 and forming it into a product.

13. A composite material product obtained by binding a cellulose-containing starting material to a binding agent according to claim 3 and forming it into a product.

14. A composite material product obtained by binding a cellulose-containing starting material to a binding agent according to claim 4 and forming it into a product.

15. A composite material product obtained by binding a cellulose-containing starting material to a binding agent according to claim 5 and forming it into a product.

16. A composite material product obtained by binding a cellulose-containing starting material to a binding agent according to claim 6 and forming it into a product.

17. A composite material product obtained by binding a cellulose-containing starting material to a binding agent according to claim 7 and forming it into a product.

18. A composite material product obtained by binding a cellulose-containing starting material to a binding agent according to claim 8 and forming it into a product.

19. A composite material product according to claim 10, characterized in that it is a board, preferably a pressed board or a laminate.
